(19) United States
(12) Patent Application Publication
(10) Pub. No.: US 2013/0132846 A1
(43) Pub. Date: May 23, 2013

(54) MULTIPLE CONCURRENT CONTRIBUTOR MAPPING SYSTEM AND METHOD

(71) Applicant: Christopher Joshua Martin, Victoria (CA)

(72) Inventor: Christopher Joshua Martin, Victoria (CA)

(73) Assignee: Clover Point Cartographics Ltd, Sidney (CA)

(21) Appl. No.: 13/679,974

(22) Filed: Nov. 16, 2012

Related U.S. Application Data
(60) Provisional application No. 61/562,381, filed on Nov. 21, 2011.

(51) Int. Cl. G06F 3/0484

(52) U.S. Cl. CPC G06F 3/0484
USPC 715/730; 715/753; 715/741

(57) ABSTRACT

A mapping system in the form of a collaborative mapping tool that allows multiple users to simultaneously edit a base map online and populate it with objects that they find of interest. Map creators may share their maps, allowing other users to view, edit or further share the maps as they are updated. A historical record is kept of changes to the maps so that they may be viewed as of any moment of their development, as a slideshow or as a video clip. Users may be restricted as to the objects they can see or edit.

This application claims the benefit of U.S. Provisional Application No. 61/562,381, filed Nov. 21, 2011, priority from the filing date of which is claimed. The disclosure of said priority provisional application is hereby incorporated herein by reference thereto.

### TECHNICAL FIELD

The disclosed subject matter is in the technical field of geomatics. The present invention relates to a mapping system and method for creating a map and allowing multiple contributors to simultaneously edit it via the internet. It also allows the map to be viewed in any of its historical stages of evolution.

### BACKGROUND

In general it is desirable for maps to be as up to date as possible, whether they be traditional printed maps or online maps. In some cases, for example when studying historical events, it may be useful to have access to a historical map. Depending on its size, it can be a substantial task for a single person to create a map. Furthermore, it can be difficult to obtain a historical map for a particular date.

### SUMMARY OF INVENTION

By allowing multiple contributors to provide updates through a common platform, a map can better reflect current conditions that are not possible through traditional, published methods.

The disclosed subject matter of the present invention provides a mapping system in the form of an online, shared mapping tool for creating a multiple contributor map. A user may inspect the map as a sequence of stills spanning the moment from its creation, through historical changes, to its current day version. Once a map has been created, multiple contributors may edit the map either by adding further features to it or by editing existing features based on the access permissions that have been assigned to them by the map creator. For example, some users may have permissions to view and/or edit only certain assets, while assets that they do not have permissions to are not visible to them. The map may be viewable through a standard browser or through an application operating within the framework of a social network website. The map may be accessed from many different types of electronic device, such as a desktop computer, a laptop computer, a smart phone, a tablet computer, a gaming system, etc. The map, once created, may be edited in real time.

Disclosed herein is a multiple contributor, playable mapping system comprising: a database storing information representing: definition of a map and a time of creation of the map; details of a plurality of assets related to the map, including for each asset: identification of the asset; graphical representation of the asset; location of the asset; time of addition of the asset to the map; and identification of a contributor who added the asset; a processor for accessing the database; a user remote electronic device; and a plurality of contributor remote electronic devices from which identifications of the assets have been received by the processor; wherein the processor is configured to: receive a time of interest from the user remote electronic device; obtain information from the database corresponding to the map at the time of interest; and display on the user remote electronic device a version of the map corresponding to the time of interest.

Further disclosed herein is a method for displaying a multiple contributor, playable map comprising the processor implemented steps of: storing, in a database, information representing definition of a map and a time of creation of the map; receiving, from a plurality of contributor remote electronic devices, definition of a plurality of assets related to the map; storing, in the database, further information representing: details of the plurality of assets, including for each asset: identification of the asset; graphical representation of the asset; location of the asset; time of addition of the asset to the map; and identification of a contributor who added the asset; receiving, from a user remote electronic device, a time of interest; obtaining information from the database corresponding to the map at the time of interest; and displaying on the user remote electronic device a version of the map corresponding to the time of interest.

### BRIEF DESCRIPTION OF DRAWINGS

The drawings illustrate embodiments of the invention but should not be construed as restricting the scope of the invention in any way.

FIG. 1 is an overview of the multiple contributor playable mapping system.

FIG. 2 is an alternate example of the database arrangement for the system.

FIG. 3 is a schematic drawing of a mobile electronic device on which a map created by the mapping system may be viewed and edited.

FIG. 4 is a schematic representation of a screenshot of an example map.

FIG. 5 is a partial screenshot showing information relating to an asset on the map.

FIG. 6 is a schematic diagram of the data organization and related functions of the system.

FIG. 7 is a schematic diagram of a map and a list of the map history detail.

FIG. 8 is a schematic diagram of how the historical map data is stored.

FIG. 9 is a view of a mobile electronic device in a horizontal orientation, displaying a list of assets on the map.

FIG. 10 is a view of a mobile electronic device in a vertical orientation, displaying augmented reality.

FIG. 11 is an example of a process performed by the system.

### DESCRIPTION

Throughout the following description, specific details are set forth in order to provide a more thorough understanding of the invention. However, the invention may be practised without these particulars. In other instances, well known elements have not been shown or described in detail to avoid unnecessarily obscuring the invention. Accordingly, the specification and drawings are to be regarded in an illustrative, rather than a restrictive, sense.

The detailed descriptions that follow are presented largely in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps require physical manipulations of physical quantities. Often, but not necessarily, these quantities take the form of electrical or magnetic signals, values or parameter capable of being stored, transferred, combined, compared, and otherwise manipulated. It will be further appreciated that the line between hardware and software is not always sharp, it being understood by those skilled in the art that software implemented processes may be embodied in hardware, firmware, or software, in the form of coded instructions such as in microcode and/or in stored programming instructions.

A user is a person who generally views the map. A contributor is a user who adds to, or edits a map. A map creator is a contributor who is the first to set up and save a map.

In the present context, an asset is a feature of a map, such as a real-life feature, a photograph of a real-life feature, a photograph taken at a specific location on a map, a video clip related to a specific location on a map, a photograph or video clip related to a region of a map, a news article relating to a location on the map, a hyperlink related to a location, an event that may be historic, current or future and is related to the location, a comment about the area, etc. It may also relate to a zoning, such as a county or school district, that may not have any identifiable corresponding real-life geographic feature. It may relate to data associated with the location, such as weather, population density, ground type, etc.

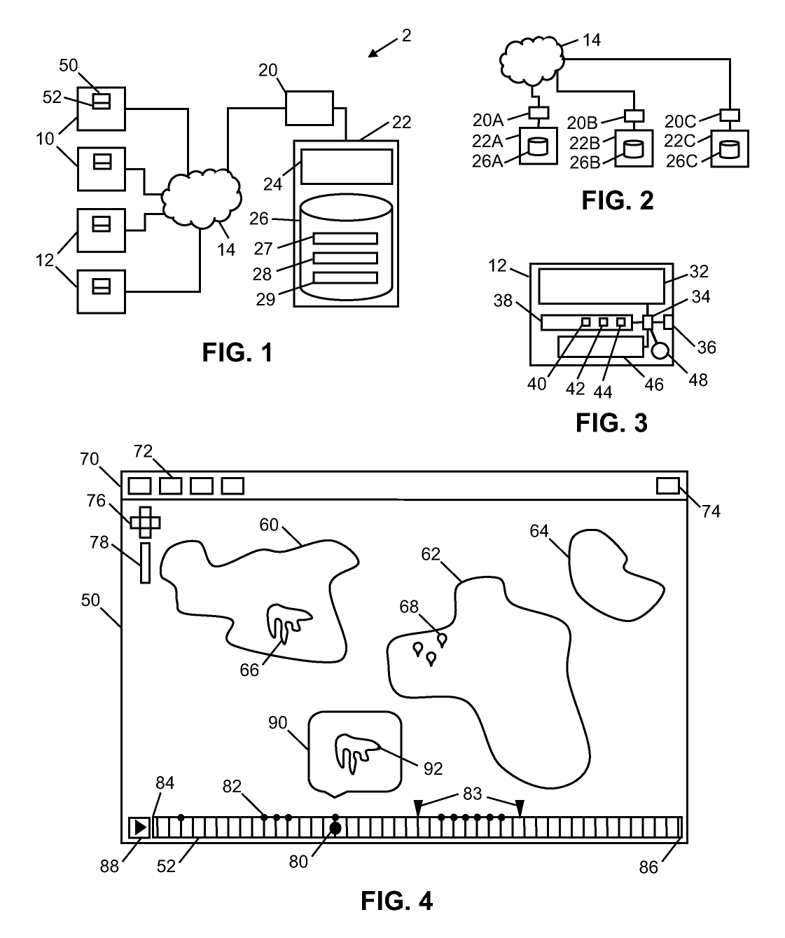

An overview of the mapping system, generally designated 2, is shown in FIG. 1. The mapping system 2 is a combination of multiple remote electronic devices 10, 12, connected via a network 14 to a processor 20 that is connected to a memory 22. The memory contains computer readable instructions 24 and data 26. Devices 10, 12 may be used by users, contributors and creators, and may be referred to as user remote electronic devices and contributor remote electronic devices in order to distinguish their use by different types of user. Nevertheless, a single device 10, 12 may be used by a person who, in relation to different maps, is a user, contributor and creator.

The electronic devices 10 may be traditional computing devices such as general purpose computers, desktop computers, portable computers, laptop computers, notebooks, gaming devices etc. Electronic devices 12 may be more modern, mobile devices such as smartphones, tablet computers, portable gaming devices, etc. Each electronic device 10, 12 whether mobile or not, has a display on which can be displayed a map 50 with a time bar or date line 52. Other electronic devices may also be used, and devices that do not have displays may be used if they are connected to peripheral displays.

The network 14 may be the internet or a telecommunications network, or both. The connections in the network 14 may be wired or wireless, although normally the connection between the network 14 and the processor 20 will be wired and the connections between the mobile devices 12 and the network will be wireless. The connections of the devices 10 to the network may be either wired or wireless.

The processor 20 and memory 22 may be located in one server or multiple servers. Memory 22 may include non-volatile and/or volatile memories, electronic memories and/or optical memories. Multiple processors may be used instead of the single one shown.

Users of devices 10, 12 may open up a web browser on their device and browse to a web site provided by the system 2. Alternately, the users may browse to a social network site which provides a framework for third party applications, and the map content provided by the system 2 may be provided within such a third party application.

Alternately, the users of mobile devices 12 may simply access the map content provided by the system 2 directly via an app (i.e. application).

Within the memory 22 the computer readable instructions 24 in the form of one or more programs provide the functionality of the system 2. The computer readable instructions 24 and data may be prepared and stored using a commonly known programming language or toolset, such as VS2010, .NET 4.0, Silverlight 4.0, Flash, IIS 7.5 Express, SQL, MEF, PHP, Javascript, etc.

The database 26 contains data 27 such as an initial definition of a map, including the date and time it was created and an identification of the contributor that created it. Further data 28 may include details of an asset that has been added to the map by a contributor, including an identification of the asset, an icon or other graphical representation of the asset, the time and date the asset was added, the identification of the contributor that added the asset, and the location of the asset. Still further data 29 may relate to an edit of an asset, including the identification of the asset, the time and date it was edited and the contributor that edited it. Data 27, 28, 29 may be received from the same or different contributors. The data may include hyperlinks, for example, which link to data stored in other servers that are not part of the mapping system 2.

Data 27-29 in the database 26 may be divided into a public information part, such as general geographic information and coordinates and a private information part, such as details of a contributor's assets. Optionally, such private information may be stored on the contributor's premises or elsewhere, and may be password protected and/or encrypted. The contributor may restrict access to this information to a specified sub-set of map users.

A database is a collection of data and the structure with which the data is organized. As such, the database 26 may exist in one location or it may be divided between multiple locations, such as multiple memories 22 each in a different server. These servers may form a computer cluster, with local links to each other, or they may be geographically remote from each other and linked via the network 14. The database 26 may be organized as one or more smaller databases, each storing a different kind of information. For example, all map data that is to be accessed by the public may be stored in one location, and the remaining, private or restricted map data may be stored in another location. In another example, data may be divided between multiple database locations based on whether the data is for a base map, features added to the map, or edits to the features. Furthermore, the database 26 may exist in multiple instances, for backup purposes or for providing different global access points. Some or all of the database 26 may be in the cloud, meaning that its storage and safekeeping is entrusted to a third party, which stores the database in one or more servers at one or more remote locations connected to the network 14.

FIG. 2 shows an example of how multiple databases may be used in an embodiment of the mapping system 2. Processors 20A, 20B, 20C in different locations are connected to the network 14 and respectively to memories 22A, 22B, 22C. Each memory 22A, 22B, 22C stores respectively a portion 26A, 26B, 26C of the database 26. Each portion 26A, 26B, 26C may in itself be a database.

Shown in FIG. 3 is an example of a mobile electronic device 12, which a user may use to interface with the mapping system 2. Basically, the mapping system 2 is accessible by any web-capable device (Windows™, Mac™, iOS™, Android™, etc.). Device 12 may, for example, be a tablet computer that is connected to the network 14 via interface 36. The device 12 has a display screen 32 in which a web browser or app can be displayed for interacting with the processor 20 and data in database 26. Device 12 includes one or more processors 34 that connect to and control the components of the device 12, such as user input component 46, which may be a multi-touch sensitive surface combined with display screen 32. A memory 38 is included for storing data and programs that can be processed by the processor 34. The memory 38 may store, for example, a browser application 40, a local app 42 of the mapping system 2 and a location determining program 44.

If a browser is not used, which may be the case in some embodiments, the local app 42 may be installed to facilitate the function of specific modules on the device. Even if a browser is used, a local component 42 may still be needed for complete functioning of the system 2.

The location determining program 44 may determine location itself or with the help of external devices. For example, such a device may be a hardware GPS device. It may operate based on A-GPS or D-GPS, or it may receive signal strengths from Wi-Fi access points that can be used by a remote server to deduce the location of the device 12. The device 12 may also include an orientation detecting device 48, which may be a compass that may optionally be combined with accelerometers, allowing the processor 34 to determine the pointing direction of the device 12 and/or changes in the pointing direction. The accelerometers may also be used in dead reckoning, to determine positional changes of the device 12 to a finer resolution than can be provided with GPS.

Referring to FIG. 4, a screen shot of an example map 50 is shown, with date line 52. The map 50 includes assets commonly found in maps, such as golf course 60, camping area 62 and nature area 64. A small lake 66 is present in the golf course. The map 50 may include data 68 from Fusion Tables™ or another composite data source. Also displayed with the map 50 is a toolbar 70, including buttons 72 which identify and are clicked on or used to activate various map tools. Such tools may be used for creating a hyperlink to the map 50 corresponding to the view currently displayed, for printing the map or for editing the map. The tools may be used for toggling different layers of the map 50 on and off. Such layers may be different types of asset, data from Fusion Tables™, satellite view, etc. A full screen button 74 may also be included, which will toggle the display to full screen mode. Pan buttons 76 and zoom slider 78 may also be included.

The date line 52 starts at the left 84 with the time and date the map 50 was first created, and finishes at the right 86 with the current date and time. A first marker 80 shows the date and time to which the current view of the map 50 corresponds. The map 50 can be displayed at any point during its life. The actual date and/or time may be shown in addition to showing the position of the first marker 80 on a sliding scale. A historical video or slide show of the map 50 may be shown by clicking the play button 88. In a slideshow, each slide could correspond to a different edit. Alternately, the changes to the map 50 may be displayed in a video on a timescale that is proportional to the real life timescale on which the map was created and edited. During play, the play button 88 may revert to a pause button. Other buttons may also be included, such as for stepping from frame to frame, rewinding, fast forwarding, etc.

Second markers 82 denote dates and times when assets were added to the map or when existing assets were edited. Third markers 83 may be used to identify a particular period of the date line, and the markers 83 may then be dragged left and right in order to zoom. In this example, the version of the map at the date and time indicated by the first marker 80 is shown, which also corresponds to a date of an edit of an asset. When the first marker 80 is moved to such a date, for example by clicking and dragging, a pop-up 90 appears with a copy 92 of the small lake asset 66 that was edited. Further information may be displayed in the pop-up 90, such as the name of the asset, the identification of the contributor that edited it and possible notes about the edit.

Edits in the time period between third markers 83 may include, for example, later definition of specific zones within the camping area 62, such as an area for tents, and area for fires and an area for tables.

Map tools activated by buttons 72 may allow the contributors to select and comment on an area of the map 50, provided that they have the required permission, which may be obtained by signing up and logging in to the mapping system 2, and if necessary receiving permission from the map creator. Such comments may be displayed as comment icons on the map 50, which can be clicked on to display the full text of the comment, the contributor who posted it and the date and/or time it was posted.

Alternately, contributors may place icons on the map 50 that link to media hosted on other websites, such as audio or music sites, photograph sites or video sites. Many different kinds of objects may be placed on the map 50, and icons for them may be selected from a library of predetermined or internationally recognized icons. The contributor may optionally be given the chance to design a new icon for assets that do not already have icons. The choice of design may be limited to using a predetermined set of shapes and colours.

Contributors are able to update the map 50 in real-time, with multiple contributors providing updates concurrently. For example, a contributor may want to update a map with his personal location, which may be done automatically if he is updating the map with a mobile device that is location aware. Automatic updates may occur every so often, either at regular intervals or after each time the contributor has moved a predetermined minimum distance. The program 24 in the server 22 will make changes to the map 50 in the order in which they are received. Concurrent updates are visible by all of the users of the map immediately after being received in the database 26.

The map 50 may be defined by its creator to be public, private or shared through a social network site. A map is created as a group of maps, with every change or addition logged in the database 26.

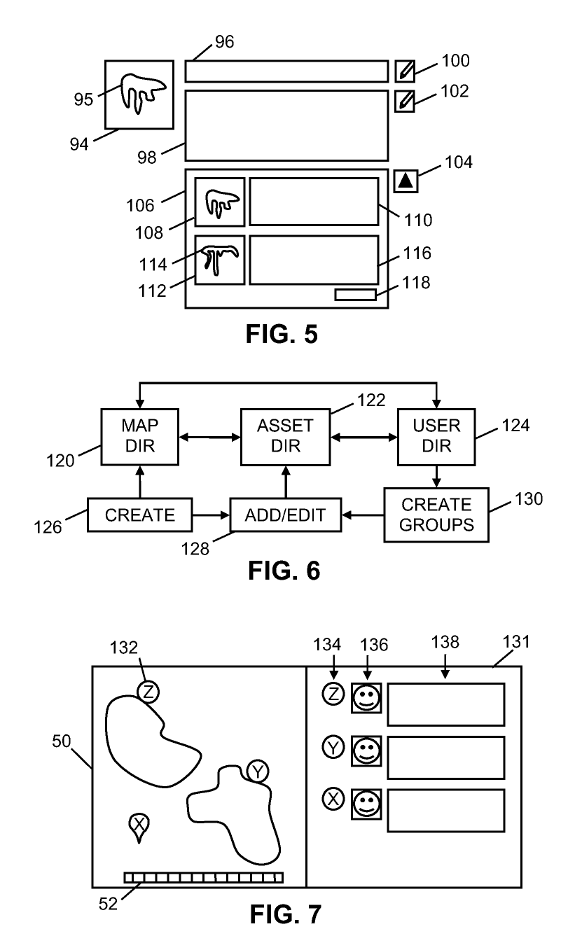

In FIG. 5 a diagram of a partial screen shot is shown of the history of a particular asset. A thumbnail drawing 94 of a copy 95 of the small lake asset 66 (FIG. 4) selected is shown for easy identification of it. Alongside the thumbnail 94 is the title 96 of the asset and a description 98 of the asset. Depending on the permission level granted to the user, i.e. if the user is a contributor, the title 96 may be edited by clicking or tapping and edit button 100. Likewise, the description 98 may be edited via edit button 102. Below the title and description there is a pull-down history detail zone 106, which may be shown and hidden using button 104. The asset history detail zone 106 shows a thumbnail 108 of its latest edit, with details 110 of the edit alongside it. Such details 110 may include the name of the contributor who edited it, the date of the edit and information relating to how the asset was edited. The asset history detail zone 106 also shows a thumbnail 112 of the asset as it appeared 114 as a result of the immediately preceding edit. Again, written details 116 including the contributor's name, date and information relating to the change may be displayed alongside the thumbnail 112. A button 118 for viewing details of more edits is also shown in cases where it is not desired or possible to show all of them at once. The creation of the asset is shown below the earliest edit. If the asset no longer exists, details of its deletion may also be shown in the asset history detail zone 106.

The asset history detail zone 106 may be displayed on a screen at the same time as the map 50, either alongside it or below it. On smaller devices with smaller screens, the display may toggle between displaying the map and displaying the asset history detail.

Referring to FIG. 6, a block diagram of the types of data and related functions for an embodiment of the mapping method of the present invention is shown. The data for a map is stored in a map directory 120 as a result of a map creator using the map creation function 126 provided by the mapping system 2. For a particular map, this includes the initial definition of the map, which may be an image file, a link to a third party map or some other definition. It may be a definition of a map that has already been created by the same map creator or a different map creator or other contributor of the system. The map creator can define the map to be public, so that it can be searched for and found on a website provided by the mapping system 2 and viewable either by all internet users or all users who are members of the mapping system 2.

Details of assets for the map are stored in an asset directory 122. Such details include graphics to be displayed on the map, thumbnails, textual information, etc. Details may include pointers to generic data stored in a common asset directory, such as image files for icons, thumbnails, standard text etc. There may be a public asset directory, with assets available to everyone who uses the system, and there may be one or more private asset directories, for private assets that are created for user specific purposes. The map directory includes a location of and reference to each asset.

Included in the map directory is a reference to the user who created the map. Actual data for the user who is the creator of the map is stored in user directory 124, such as personal details and passwords. The creator of a private map may invite or approve other users to access the map using the Create Groups function 130. Details of such users are stored in the user directory 124. Users may be invited through a social network site, such as provided by FaceBook™, or Google+™, or via email, for example. The ability to either view or update a map is restricted by the permissions assigned by the creator of the map to each user. Users may be grouped into sets, with each set being given a different approval level. Users can be assigned permissions to just view the map, or, if they are to be contributors, to add or edit points on the map using the Add/Edit function 128, or even invite others to view the map. These permissions can be set by the map creator at the time that the map is created or changed at any time afterwards. The playable mapping system and method for creating a map allows multiple user/contributors to simultaneously, or at separate times, edit it via the internet.

When a contributor adds a point to a map they will be able to add a description and link external media to that point. This media could be a picture stored in a FaceBook™ or Flickr™ album, a video on YouTube™ or another streaming video service, or an audio file shared on the cloud. Each point is associated with an icon, which can be selected from an existing asset type library or a custom file uploaded by the contributor.

The creation of the map may be the moment a base map is first defined, or it may be after the creator of the map has added one or more assets to it. The map creator can set a default starting point and scale for each map. This default setting can be personalized by individual users of the map to start them off at a different starting point without altering the default setting for other users.

The mapping system is based on shared services, and can pull map services from Open Street™ Maps or any other online map service, such as Bing™ Maps or Google™ Maps. Users may use login credentials from social media sites, and the system makes use of third party media storage sites to keep the application footprint to a small size while providing a rich, functional environment.

FIG. 7 shows a display of the map 50 alongside a listed history 131 of the map as a whole. The map 50 includes the display of markers 132 for each asset, each marker corresponding to a row in the map history list 131. The map history list 131 has a marker column 134 containing the markers for each of the assets visible on the map, a contributor identification column 136, which may contain images for the contributors who contributed to the map and/or names of the contributors, and a column for descriptions relating to the assets. The descriptions shown may correspond to the latest edit of the asset, the initial addition of the asset or an expandable list of the complete history of the asset such as in FIG. 5. Alternately, the expandable list of a specific asset's history detail may be shown below the map when the corresponding row in the map history is selected. The row may be selected either by selecting the row itself or by selecting or moving a cursor over the asset as displayed on the map or over the asset marker 132 on the map 50.

Rows in the map history list 131 may be shown with the most recent first. In alternate embodiments, the earliest may be shown first. If a particular moment in the history of the map 50 is selected using the date line bar 52, the rows in the map history 131 may be automatically changed to correspond to the displayed version of the map.

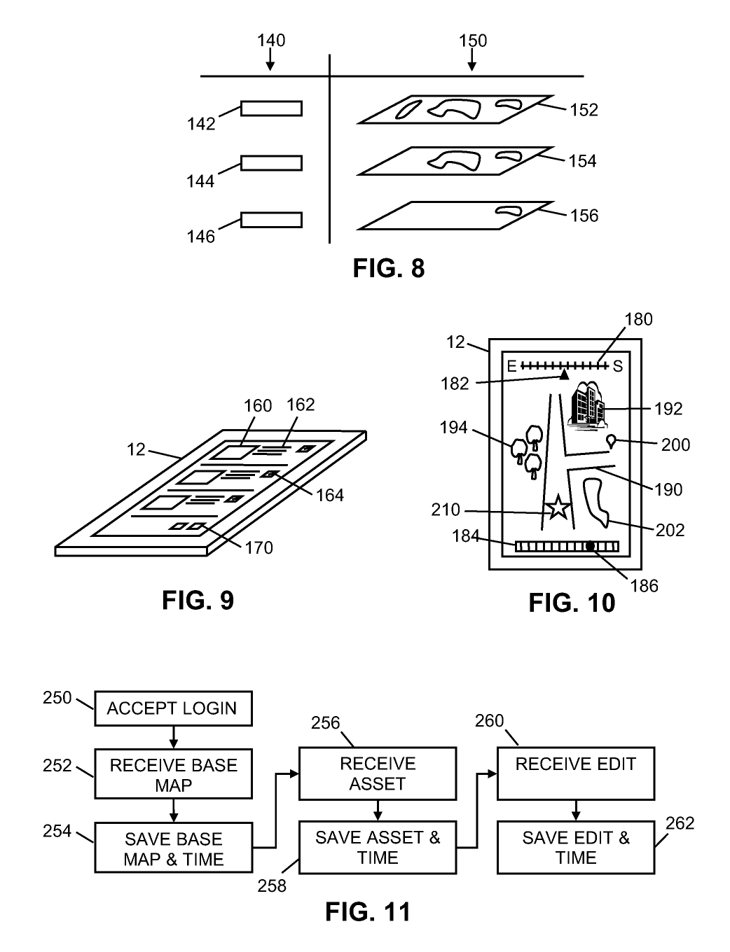

Referring to FIG. 8, a pictorial diagram is shown of how the data of the maps is stored in the database 26. The first column 140 includes dates and times of various versions of the map, which are stored in the second column 150. In practice, column 150 will exist as multiple database columns. For example, the latest date and time 142 may correspond to the map version 152, earlier date and time 144 may correspond to map version 154 and initial date and time 146 may correspond to the map version 156 as initially created.

FIG. 9 shows a mobile device 12 that is wirelessly connected to the mapping system. The mapping system is available on mobile devices, such as iOS™ and Android™ devices, although it may be with limited functionality compared to more traditional computing devices such as laptops and desktops. Users are able to view maps and, if they are also contributors, to add and/or edit asset information. They may not be able to create a new map, edit asset types or manage users, for example, but this will depend on the embodiment chosen. Device 12 is in a horizontal orientation, and is shown displaying a list of assets of a map. Each asset listed may include a thumbnail 160, a description 162 and an edit button 164. Tool buttons 170 may also be displayed, allowing the user to take a picture and add it as an asset to the map, for example, or for navigating to different pages of the mapping site.

If the mobile electronic device 12 is equipped with a camera and tilted into a vertical orientation, as shown in FIG. 10, it may be configured to enter an augmented reality mode. At the top of the screen a pointing direction scale 180 is shown with a marker 182 to indicate the current pointing direction or heading of the device 12. At the bottom of the screen a date line 184 is shown, with a marker 186 indicating the time and date of the version of the map, which in this case is a map of augmentations to reality. The device displays a camera view of real life objects such as roads 190, buildings 192 and trees 194, as well as the assets of the augmented reality map such as marker 200 and natural area of interest 202. Each of the assets may be tapped by the user to access further information or to edit them. In some embodiments the view from the camera may be switched off, and only the augmentation assets shown. In this case, the system may optionally be configured to display a marker 210 indicating the current location of the user. This will allow the user to zoom in and out while retaining a reference point, or even virtually walk through the map, which may include three dimensional assets.

The map may correspond to a tour that a contributor has taken. In this case, the location of the contributor may be shown with marker 210, which may be shown to move through the map as the map is played. The map may be static and the marker may move, or the marker may be static at the foot of the screen and the viewpoint of the map may change as it is played, such that the contributor views the map in a direction corresponding to the direction in which he was moving at the time the map was recorded.

FIG. 11 shows the process the mapping system 2 performs as a map is created and edited. In step 250 the mapping system accepts a user's valid login credentials. The map creator creates a base map, the definition of which is received by the system in step 252 and saved to the database 26 in step 254 with a timestamp corresponding to its creation. After the base map has been saved, the system 2 then receives in step 256 the definition of an asset, after which it is saved in step 258 together with a timestamp of the addition of the asset. If the map creator desires to add further assets, the system 2 may revert back to step 256 to receive definitions of further assets. After an asset has been defined, it may be edited by the map. The system 2 accepts an edit of an asset in step 260, then saves the changes and a timestamp in step 262. If the map creator wishes to make further edits, the system 2 may revert back to step 260. Other users may log into the mapping system 2 once a map has been created, and, provided permission has been granted, the system may receive asset additions in step 256 or asset edits in step 260 from the other users who are contributors.

A benefit of the system 2 is the ability to allow multiple contributors to provide simultaneous changes to the maps, which are immediately viewable by other users of the map. A further benefit is that map information can be restricted by the creator of the map, so that some users and/or contributors are able to see all assets, while other users and/or contributors are able to see only some assets. Likewise, some contributors may be able to edit all the assets, while other contributors may only have the ability to edit some of those assets. These features are not mutually exclusive, and both may be included. One example is that a restricted group of users, having the ability to see only some of the assets, may also be contributors, and can simultaneously update the map as well.

Where time-based data is recorded against map assets using the mapping system 2, such a map can also be used to display proposed changes in the future. This may be achieved by allowing the time bar 52 to extend to times later than the current time.

Modules, components, features, directories, functions etc. of the architecture and/or framework of the invention may be grouped, linked, split or otherwise organized differently to the embodiments shown herein. Some may be omitted, and others added. The order in which features are displayed may be reversed, or otherwise different. As will be apparent to those skilled in the art in the light of the foregoing disclosure, many alterations and modifications are possible in the practice of this invention without departing from the scope thereof. Accordingly, the scope of the invention is to be construed in accordance with the substance defined by the following claims.

I claim:

1. A multiple contributor, playable mapping system comprising:
one or more databases storing information representing:
definition of a map and a time of creation of the map;
details of a plurality of assets related to the map, including for each asset:
identification of the asset;
graphical representation of the asset;
location of the asset;
time of addition of the asset to the map; and
identification of a contributor who added the asset;
one or more processors for accessing said one or more databases;
a user remote electronic device; and
a plurality of contributor remote electronic devices from which identifications of said assets have been received by the processor;
wherein the one or more processors are configured to:
receive a time of interest from the user remote electronic device;
obtain information from the one or more databases corresponding to the map at said time of interest; and
display on the user remote electronic device a version of the map corresponding to said time of interest.

2. The system of claim 1 wherein the one or more processors are further configured to display a slide show of consecutive versions of the map on the user remote electronic device.

3. The system of claim 1 wherein the one or more processors are further configured to display a video of the map on the user remote electronic device, on a timescale that is proportional to a real life timescale of the map.

4. The system of claim 1 wherein the one or more processors are further configured to display a date line on the user remote electronic device, wherein the time of interest is determined by a position of a marker that is slidable along the date line.

5. The system of claim 4 wherein the one or more processors are further configured to display on the date line a second marker, corresponding to one of said times of addition of an asset to the map.

6. The system of claim 4, wherein the date line is configured to be zoomed.

7. The system of claim 4 wherein the date line extends into the future and at least one of the assets is a proposed asset.

8. The system of claim 1 wherein:
the one or more databases store identifications of assets which a user of the user remote electronic device has permission to view; and
the one or more processors are configured to display, in the version of the map, only the graphical representations of the assets for which the user has permission.

9. The system of claim 1 wherein:
the one or more databases store identifications of assets which a user of the contributor remote electronic device has permission to edit; and
the one or more processors are further configured to receive edits for those assets for which the user has permission.

10. The system of claim 1 wherein the one or more processors are further configured to display, on the user remote electronic device, an identification of a contributor of one of said assets.

11. The system of claim 10 wherein the one or more processors are further configured to display, on the user remote electronic device, a history of edits of at least one of said assets.

12. The system of claim 1 wherein the one or more processors are further configured to receive said details of assets concurrently from said plurality of contributor remote electronic devices.

13. The system of claim 12 wherein the one or more processors are further configured to:
receive edits of said details of assets concurrently from said plurality of contributor remote electronic devices;
store the edits in the database; and
immediately upon storing the edits in the one or more databases, make the edits available to be displayed on the user remote electronic device.

14. The system of claim 1 wherein the one or more processors are further configured to display on the contributor remote electronic device and/or the user remote electronic device a historical list, which includes one or more historical details of at least one asset of the displayed version of the map.

15. The system of claim 1, wherein the user remote electronic device has a camera and the one or more processors are further configured to display the map in an augmented reality mode.

16. The system of claim 1 wherein the user remote electronic device is also a contributor remote electronic device.

17. A method for displaying a multiple contributor, playable map comprising the processor implemented steps of:
storing, in one or more databases, information representing definition of a map and a time of creation of the map;
receiving, from a plurality of contributor remote electronic devices, definition of a plurality of assets related to the map;
storing, in the one or more databases, further information representing:
details of the plurality of assets, including for each asset:
identification of the asset;
graphical representation of the asset;
location of the asset;
time of addition of the asset to the map; and
identification of a contributor who added the asset;
receiving, from a user remote electronic device, a time of interest;
obtaining information from the one or more databases corresponding to the map at said time of interest; and
displaying on the user remote electronic device a version of the map corresponding to said time of interest.

18. The method of claim 17 further comprising:
displaying, on the user remote electronic device, a slide show of consecutive versions of the map; or
displaying, on the user remote electronic device, a video of the map on a timescale that is proportional to a real life timescale of the map.

19. The method of claim 17 further comprising:
receiving said details of assets or edits of said assets concurrently from said plurality of contributor remote electronic devices;
storing the edits in the one or more databases; and
immediately upon storing the edits in the one or more databases, making the edits available to be displayed on the user remote electronic device.

20. The method of claim 17 further comprising:
storing, in the one or more databases, identifications of assets which a first user of the user remote electronic device has permission to view;
displaying, in the version of the map, only the graphical representations of the assets for which the first user has permission;
storing, in the one or more databases, identifications of assets which a second user of the contributor remote electronic device has permission to edit; and
receiving edits for only those assets for which the second user has permission.
